(19) United States
(12) Patent Application Publication
(10) Pub. No.: US 2024/0065283 A1
(43) Pub. Date: Feb. 29, 2024

(54) PROCESS FOR PRODUCING A NUTRITIONAL PRODUCT COMPRISING WHEY PROTEIN AND OLIGOSACCHARIDE

(71) Applicant: FrieslandCampina Nederland B.V., Amersfoort (NL)

(72) Inventor: Leon Franciscus Mallee, Wageningen (NL)

(21) Appl. No.: 18/038,791

(22) PCT Filed: Dec. 7, 2021
(86) PCT No.: PCT/EP2021/084632

§ 371 Date: May 25, 2023

(30) Foreign Application Priority Data
Dec. 8, 2020 (EP) 20212499.6

(51) Int. Cl. A23C 21/02; A23C 21/08; A23L 33/19

(52) U.S. Cl. CPC A23C 21/026; A23C 21/08; A23L 33/19; A23C 2220/20

(57) ABSTRACT

The invention relates to a process for producing a nutritional product comprising fermented whey protein by subjecting an aqueous medium comprising non-digestible oligosaccharides and either whey protein concentrate (WPC) or whey protein isolate (WPI) to at least one strain of lactic acid bacteria and optionally yeast. Compared to acidified whey protein drinks, a drink based on fermented whey has a better taste due to the broader acid spectrum and does not need separate acid addition for obtaining an ambient stable product.

### CROSS REFERENCE TO RELATED APPLICATIONS

This application is a U.S. national phase application of International Application No. PCT/EP2021/084632, filed Dec. 7, 2021, which claims benefit from European Application No. 20212499.6, filed Dec. 8, 2020, which are each hereby incorporated herein by reference in their entirety.

### FIELD

The present invention relates to a nutritional product comprising whey protein and non-digestible oligosaccharide. Said product can be used to improve sleep quality and/or sleep continuity, athletic performance, and/or muscle building of a human subject.

### BACKGROUND

It is well-known that a qualitative sleep is important for brain function. Furthermore, there are indications that muscle building is affected by sleep. Testosterone is an important hormone for muscle building and is exclusively produced during sleep. It is furthermore known that sleep can be affected by nutrition and lifestyle.

Proteins are the suppliers of dispensable and indispensable amino acids. At least two of the indispensable amino acids, tryptophan and tyrosine, have been linked to sleep and alertness/attention. Both are precursors of neurotransmitters—serotonin and catecholamines—which play in important role in the processes of sleep and alertness.

Whey proteins, in particular α-lactalbumin, contain the highest levels of tryptophan of all milk proteins.

Whey proteins, because of their unique amino acid composition, are furthermore recognized for their ability to optimize aspects of immune function, with perhaps their best-characterized action being stimulation of glutathione production. Glutathione (GSH) is synthesized from cysteine, glutamate, and glycine. It plays a major role in protection of cells against oxidative stress. Interestingly, GSH has also been implicated in sleep regulation. Studies in rats have shown that oxidized glutathione (GSSG) significantly enhanced slow wave sleep and paradoxical sleep at the expense of wakefulness during a 12-h dark period, which supports the hypothesis that glutathione may be a sleep-inducing factor in the brain.

PCT/EP2019/076595 discloses beneficial effects on the duration and quality of sleep in human adults of a nutritional composition comprising (i) 1-40 wt %, based on solids content, of galacto-oligosaccharides (GOS), and (ii) a protein source providing L-tryptophan (Trp) and L-cysteine (Cys). The protein providing Trp and Cys is present in an amount that provides Cys and Trp each in an amount of about 4-15 wt. % relative to the weight of GOS. Very good results were obtained upon ingestion of a composition providing 0.3-0.6 gram Trp, about 0.3-0.6 gram Cys and about 3.5-8 gram of GOS prior (e.g. 1-2 hours) to bedtime.

A favorable protein source of Trp and Cys appeared to be whey proteins, such as alpha-lactalbumin.

### DETAILED DESCRIPTION

It has now been found that whey protein that is fermented with lactic acid bacteria allows for a higher protein and, hence, Trp and Cys concentration in a smaller volume. Fermentation also allows for the formation of lactose-free products. Furthermore, fermented proteins are more easily digestible, and thereby liberate Trp and Cys faster. It is also known that fermented products have a high anti-oxidant activity.

Compared to acidified whey protein drinks, a drink based on fermented whey has a better taste due to the broader acid spectrum and does not need separate acid addition for obtaining an ambient stable product.

Preferably, the whey protein is fermented with both lactic acid bacteria and yeast.

Even more preferably, the whey protein that is fermented is a whey protein concentrate (WPC) or whey protein isolate (WPI) with a protein concentration of at least 60 wt %. A higher concentrated whey protein source implies a reduced lactose content. The latter is desired as it reduces the formation of undesired flavor components during the fermentation.

According to the present invention, the whey protein is fermented in the presence of non-digestible oligosaccharides selected from fructo-oligosaccharides (FOS) and galacto-oligosaccarides (GOS). Apart from the beneficial effect of these oligosaccharides on gut microbiota and their consequential effect on sleep, the presence of these compounds during the fermentation results in a beneficial sweet note to the taste.

Furthermore, due to the presence of these oligosaccharides during fermentation, lactose consumption is reduced and mono- and disaccharides, which are naturally present in the oligosaccharide sources, are consumed by the lactic acid bacteria, thereby resulting in a product low in mono- and disaccharides without requiring purification steps.

The present invention therefore relates to a process for producing a nutritional product comprising fermented whey protein, said process comprising the steps of:
(i) providing an aqueous medium comprising (based on total weight of the aqueous medium):
   a) 2-20 wt % non-digestible oligosaccharides selected from fructo-oligosaccharides (FOS) and/or galacto-oligosaccarides (GOS) and
   b) 5-25 wt % whey protein

(ii) subjecting said medium to at least one strain of lactic acid bacteria for a period of time allowing the pH of the medium to drop to 4.6 or below.

According to a first embodiment, the aqueous medium is obtained by dispersing in water (a) said non-digestible oligosaccharides and (b) a whey protein concentrate (WPC) or whey protein isolate (WPI) with a protein content of at least 60 wt % (based on dry matter)

In a second embodiment, the aqueous medium is subjected to at least one strain of lactic acid bacteria and at least one strain of yeast for a period of time allowing the pH of the medium to drop to 4.6 or below.

The advantage of using a combination of lactic acid bacteria an yeast(s) is that it provides a more diverse, and therefore healthier product. Furthermore, yeasts are rich in B-vitamins, which have a positive effect on sleep, and allows to obtain a drink with mild carbonation. Any glucose present in the aqueous medium will be consumed by the yeast.

The aqueous medium comprising 5-25 wt % whey protein can be obtained by dispersing, in water, WPC or WPI with a protein content of at least 60 wt %, more preferably at least 70 wt %, even more preferably at least 80 wt %, and most preferably at least 90 wt %, based on dry matter.

It has been found that the use of whey products with lower protein content leads to taste defects, such as aromatic off-flavors and/or highly acidic/sour taste. The use of WPC or WPI with a protein content of at least 60 wt % leads to a more neutral taste; generally perceived as pleasant.

In addition, WPC and WPI with this high content of protein—in contrast to whey and whey powder—are low in lactose. This allows for the production of low lactose products without the need for adding lactases to reduce the lactose content. Moreover, this low lactose content prevents post acidification, because the microbes stop growing when all lactose has been consumed. For instance, acid tolerant species such as Lactobacilli will keep producing acid as long as lactose is available.

WPC is conventionally prepared by ultrafiltration of whey, optionally followed by diafiltration. WPI is conventionally prepared by ultrafiltration or ion-exchange of whey. WPC and WPI are generally available in spray-dried form.

The preferred source of WPC or WPI is acid whey. Acid whey is a byproduct of the acid precipitation of casein, for instance in the production of acid type dairy products like cottage cheese or strained yoghurt.

Sweet whey (also called cheese whey) is the byproduct of the production of rennet types of cheese. It has been found that WPC and WPI obtained from sweet whey results in more taste defects, e.g. highly acidic/sour taste, than WPC and WPI obtained from acid whey. Furthermore, acid whey proteins generally contain more cysteine and tryptophan; amino acids that are known to affect sleep.

The whey protein concentration of the aqueous medium is in the range 5-25 wt %, more preferably 8-25 wt %, and most preferably 10-20 wt %.

The aqueous medium is preferably suitable for human consumption, meaning that it does not contain peptone, nor any or other materials/growth media that are not suitable for human consumption. As a result, the fermented aqueous medium can be directly consumed or incorporated in a nutritional composition without separation steps.

The aqueous medium also comprises non-digestible oligosaccharides selected from fructo-oligosaccharides (FOS) and galacto-oligosaccarides (GOS). In addition thereto, also human milk oligosaccharides (HMO) may be present in the aqueous medium. Examples of human milk oligosaccharides are fucosylated lactoses such as 2′-fucosyllactose (2′-FL) and 3′-fucosyllactose (3′-FL), sialylated lactoses such as 3′-sialyllactose (3′-SL) and 6′-sialyllactose (6′-SL), and tetrasaccharides like lacto-N-tetraose (LNT) and lacto-N-neotetraose (LNnT).

The concentration of FOS and/or GOS in the aqueous medium is in the range 2-20 wt %, preferably 2-18 wt %, more preferably 2-16 wt %, even more preferably 2-15 wt %, more preferably 6-16 wt %, even more preferably 6-12 wt %, and most preferably 8-10 wt %.

GOS and FOS are carbohydrate components that are not digestible by humans, but is which have been shown to have a growth-promoting effect on bifidobacteria and lactobacilli in the gut.

The basic structure of GOS includes a lactose core at the reducing end which is elongated with up to about seven galactose residues (degree of polymerization of 8; DP8). Commercial GOS preparations are generally produced via a transgalactosylation reaction by enzymatic treatment of lactose with β-galactosidases (EC.3.2.1.23), yielding a mixture of oligomers with approximately 100 different types structures with varying DP and linkages. Beta-galactosidase is produced in many microorganisms such as Bacillus circulans, Aspergillus oryzae, Kluyveromyces marxianus, Kluyveromyces fragilis, Sporobolomyces singularis, Lactobacillus fermentum, and Papiliotrema terrestris (Cryptococcus Papiliotrema terrestris).

Fructooligosaccharides (FOS) are commercially produced by either inulin degradation or transfucosylation processes. Inulin is a naturally occurring polysaccharide produced by many types of plants, and is industrially most often extracted from chicory. Inulin is a polyfructose: a polymer of D-fructose residues linked by β(2→1) bonds with a terminal α(1→2) linked D-glucose. The degree of polymerization of inulin ranges from about 10 to about 60. Inulin can be enzymatically or chemically degraded to a mixture of oligosaccharides with the general structure Glu-Fruₙ (GFn) and Fruₘ (Fm), with n and m ranging from 1 to about 7. This process also occurs to some extent in nature, and these oligosaccharides can be found in a large number of plants, especially in Jerusalem artichoke, chicory and the blue agave plant. The main components of commercially FOS are kestose (GF2), nystose (GF3), fructosylnystose (GF4), bifurcose (GF3), inulobiose (F2), inulotriose (F3), and inulotetraose (F4). The second class of FOS is prepared by the transfructosylation action of a β-fructosidase (from, e.g. Aspergillus niger or Aspergillus) on sucrose. The resulting mixture has the general formula of GFₙ, with n ranging from 1 to 5.

The at least one lactic acid bacteria strain to be used in the processes of the present invention is preferably selected from the group consisting of Lactobacilli, Lactococci, Bifidobacteria, Leuconstoc, Streptococci, Enterococci, Propionibacteria, and Pediococci. Examples of suitable lactobacilli are Lactobacillus paracasei and Lactobacillus gasseri. Examples of suitable Bifidobacteria are Bifidobacteria bifidum and Bifidobacteria adolecentis. Most preferably, species are used that do not consume Gal-Gal (DP2) from the oligosaccharide mixture, because DP2 plays an important role in the maintenance of the integrity of the gut. Examples of strains that do not utilize DP2 are B. lactis W51 & W52, B. animalis W53, L. casei W56 and E. faecium W54. The at least one strain of yeast that is used in the second embodiment of the present invention is preferably selected from the group consisting of Kluyveromyces, Debaryomyces, Candida, Saccharomyces, Zygosaccharomyces, Schizosaccharomycs, and Yarrowia. Examples of suitable species are Kluyveromyces spp. Most preferably by Kluyveromyces marxianus or Kluyveromyces lactis In a preferred embodiment, a kefir starter culture or kefir grains are used as a source of both lactic acid bacteria and yeast strains. As an alternative, Kombucha can be used. The inoculation density is preferably between 1×10² and 5×10¹⁰, more preferably between 1×10⁴ and 5×10⁹, and most preferably between 1×10⁷ and 1×10⁹ cfu lactic acid producing bacteria/ml aqueous medium. The final bacteria density after fermentation is preferably between 1×10³ to 1×10¹⁰, more preferably between 1×10⁴ to 1×10⁹ cfu/ml aqueous medium.

The fermentation is preferably performed at a temperature in the range 20-50° C., more preferably 30-45° C., most preferably 37-42° C.

The incubation is preferably performed at a pH of 4 to 8, more preferably 6 to 7.5.

The fermentation is preferably conducted at a temperature in the range 20-42° C., preferably 25-35° C., most preferably 28-32° C. During fermentation, lactic acid is formed and the pH drops. The fermentation is conducted for a period of time allowing the pH of the medium to drop to 4.6 or below, preferably 4.5 or below. The pH preferably does not drop below 4.2.

At this pH, a microbial safe and stable liquid product is obtained without requiring high temperature sterilization.

The resulting fermented liquid nutritional product may optionally be pasteurized (e.g. at least 72° C., for at least 15 seconds).

Instead of pasteurization, or following pasteurization, the product may be dried, preferably spray-dried.

The nutritional product according to the invention preferably has an acidity <150 mmol/kg, more preferably below <120 mmol/kg, most preferably <110 mmol/kg. The acidity is determined by titration till neutral using NaOH and the acidity refers to the required amount of NaOH per kg product. At high acidities, the taste of the product will is not be appealing.

The nutritional product obtainable by the process described above, optionally after pasteurization and drying, may be used for improving sleep quality and/or sleep continuity, athletic performance, and/or muscle building of a human subject.

The human subject is preferably at least 12, preferably at least 18, more preferably at least 30, even more preferably at least 50 years of age.

“Improving sleep quality and/or sleep continuity” includes one or more, preferably two or more of the following aspects: promoting falling asleep; inducing or supporting a mature sleep pattern; reducing or preventing sleep disturbances/sleeping more time while in bed; increasing the feeling of a deep sleep; feeling more refreshed at waking up; and/or feeling more energized and/or having a better mood during daytime.

The nutritional product is suitable for people with sleep disorders as well as for persons without chronic sleep problems (“sleep-healthy” people). The nutritional product is particularly suitable for those not suffering from morbid sleep, but instead having a lack of sleep, are exposed to a sleep deprivation, and/or have an increased need for sleep.

The nutritional product is preferably consumed 0-120 minutes, more preferably 0-60 minutes, and most preferably 0-30 minutes before going to bed.

It is preferably consumed in a dosage of 60-100 ml, preferably around 100 ml per serving.

The nutritional product may be formulated in any desirable form. For example, the product may be in a dry, liquid or semi-liquid state. In a preferred embodiment, it is in the form of unit dosage forms that are consumed orally, such as tablets, capsules, pills, lozenges, wafers, powders, liquids, emulsions, suspensions, solutions, or the like. Preferred formulations include liquid suspensions, powders (e.g. to be reconstituted with water, juice, milk, or any other suitable beverage prior to use), or tablets. As used herein, the term “beverage” or “drink” refers to any liquid or semi-solid form suitable for oral consumption by a human subject, and also includes concentrates, such as frozen concentrates or freeze-dried powders that can be dissolved in a suitable volume of liquid carrier to generate an instant liquid or semi-solid suitable for oral consumption. For example, when administered in the form of a beverage, the product of the present invention may be water-based, milk-based, tea-based, fruit juice-based, or some combination thereof.

The nutritional product may be used as ingredient in a nutritional composition containing additional nutritional agents, such as vitamins, minerals, and/or biologically active peptides. Said nutritional composition can be a food or a beverage, such as a dietary supplement bar or shake.

Examples of vitamins and minerals are magnesium, zinc, vitamin B3 and vitamin B6. The vitamins and minerals may be present in any effective relative or absolute amount. Vitamin B3 may be present at about 0.025 to 0.1 wt. % of the total dry weight of the composition. Vitamin B6 may be present at about 0.002 to 0.01 wt. % of the total dry weight of the composition. Good results are obtained when vitamin B3 and vitamin B6 are used in a relative weight ratio in the range of 20:1 to 1:1, preferably 15:1 to 5:1. For example, the nutritional composition is formulated to provide a daily amount (divided over e.g. one or two dosage units) of about 5-15 mg vitamin B3 and about 0.5-2 mg vitamin B6.

Magnesium may be present at about 0.5-1.5 wt. % of the total dry weight of the composition. In a specific aspect, a single serving size of the composition comprises about 100-300 mg magnesium.

Zinc may be present at about 0.01 to 0.05 wt. % of the total dry weight of the composition. In a specific aspect, a serving size of the composition comprises about 2 to 15 mg zinc, preferably about 2 to 10 mg zinc per serving.

Examples of bioactive peptide(s) are polypeptides with up to about 20 amino acids in length. A preferred peptide is a peptide resulting from tryptic digestion of casein. In one embodiment, it is an casein tryptic hydrolysate containing a bioactive peptide that acts on GABA receptors.

The nutritional composition may further contain flavoring agents, preservatives and/or coloring agents.

### EXAMPLES

### Example 1

A 10 wt % protein and 8 wt % GOS solution was prepared by dissolving Nutri Whey™ 800 (protein content 80 wt %) and Biotis™ GOS in demineralized water. The pH was then adjusted to 6.8-7.0 using a 10 wt % KOH solution. The solution was pasteurized, cooled to 30° C. and inoculated using eXact Kefir 12 (Chr. Hansen) using the equivalence of 20 DCU per 100 l. After 12 hours the fermented solution was evaluated. The results are listed in Table 1.

### Example 2

A 8 wt % protein and 5 wt % GOS solution was prepared by dissolving Nutri Whey™ 800 and Biotis™ GOS in demineralized water. The pH was then adjusted to 6.8-7.0 using a 10 wt % MgOH solution. The solution was pasteurized, cooled to 30° C. and inoculated using ABT-6 (Chr. Hansen) and LAF4 (Chr. Hansen) using the equivalence of 20 and 0.2 DCU per 100 l, respectively. After 16 hours the fermented solution was evaluated. The results are listed in Table 1.

### Example 3

A 8 wt % protein and 5 wt % GOS solution was prepared by dissolving Nutri Whey™ 800 and Biotis™ GOS in demineralized water. Hereafter, 0.1 wt % of a partially hydrolysed whey protein (Hyvital® Whey ETD 100) was added. The pH was then adjusted to 6.7 using a 10 wt % KOH solution. The solution was pasteurized, cooled to 24° C. and inoculated using eXact Kefir 12, RSF-636 and LAF4 (all Chr. Hansen) using the equivalence of 20.5 and 0.2 DCU per 100 l, respectively. After 16 hours the pH was reduced to about 4.6 and the fermented solution was evaluated. The results are listed in Table 1.

The resulting product had a lactic acid bacteria plate count of 2.4·10⁹ and a yeast plate count of 2.4·10⁵; these high plate counts indicate that the product has been fermented by these bacteria and yeast.

TABLE 1
Overview of product characteristics

| | | Acidity | | | |
|---|---|---|---|---|---|
| | pH | (mmol/kg) | Smell | Taste | Appearance |
| Example 1 | 4.43 | 73.7 | Fresh, yogurt | Fresh, sweet, | |
| | | | like | cereals | |
| Example 2 | 4.40 | 77.0 | Acidic, bland, | Fresh, sweet, | |
| | | | buttery | watery | |
| Example 3 | 4.58 | 103.2 | Mild, acidic | Medium | Stable turbid |
| | | | | acidic, light | white/yellowish |
| | | | | sweet, fresh | solution |

### Example 4

Taste comparison was done between the fermented product obtained in Example 3 and the acidified whey/GOS solution that served as the fermentation medium in Example 3.

Both samples were given to a trained sensory panel consisting of 10 trained individuals. The panelists were asked to describe the product attributes and were asked to choose the product they preferred. The results showed a clear preference for the fermented product.

1. Process for producing a nutritional product comprising fermented whey protein, said process comprising the steps of:
(i) providing an aqueous medium comprising:
a) 2-20 wt % non-digestible oligosaccharides selected from fructo-oligosaccharides (FOS) and/or galacto-oligosaccarides (GOS) and
b) 5-25 wt % whey protein; and
(ii) subjecting said medium to at least one strain of lactic acid bacteria for a period of time allowing the pH of the medium to drop to 4.6 or below.

2. Process according to claim 1 wherein the aqueous medium is provided by dispersing in water said non-digestible oligosaccharides and a whey protein concentrate (WPC) or whey protein isolate (WPI) with a protein content of at least 60 wt % based on dry matter.

3. Process according to claim 1 wherein the aqueous medium is subjected to at least one strain of lactic acid bacteria and at least one strain of yeast for a period of time allowing the pH of the medium to drop to 4.6 or below.

4. Process according to claim 1, further comprising the additional step of pasteurizing the product resulting from step (ii).

5. Process according to claim 1, further comprising the additional step of drying the optionally pasteurized product resulting from step (ii).

6. Process according to claim 1, wherein the concentration of whey protein in said aqueous medium is in the range 10-20 wt %.

7. Process according to claim 1, wherein the aqueous medium is obtained by dispersing acid whey protein concentrate or acid whey protein isolate in water.

8. Process according to claim 1, wherein the aqueous medium is obtained by dispersing in water WPC or WPI with a protein content of at least 70 wt % based on dry matter.

9. Process according to claim 1, wherein the at least one lactic acid bacteria strain is selected from the group consisting of Lactobacilli, Lactococci, Bifidobacteria, Leuconstoc, Streptococci, Enterococci, Propionibacteria, and Pediococci.

10. Process according to claim 3 wherein the at least one strain of yeast is selected from the group consisting of Kluyveromyces, Debaryomyces, Candid, Saccharomyces, Zygosaccharomyces, Schizosaccharomycs, and Yarrowia.

11. Process according to claim 3 wherein a kefir starter culture or kefir grains are used as a source of both lactic acid bacteria and yeast strains.

12. Process according to claim 1, wherein the aqueous medium is suitable for human consumption.

13. Process according to claim 1, wherein the aqueous medium comprises 6-12 wt % non-digestible oligosaccharides selected from fructo-oligosaccharides (FOS) and/or galacto-oligosaccarides (GOS).

14. Nutritional product obtained by the process of claim 1.

15. A method of improving sleep quality and/or sleep continuity, the athletic performance, and/or muscle building of a human subject, the method comprising administering to the human subject an effective amount of the nutritional product of claim 14.

16. Process according to claim 10 wherein a kefir starter culture or kefir grains are used as a source of both lactic acid bacteria and yeast strains.

17. Process according to claim 1, wherein the non-digestible oligosaccharides selected from fructo-oligosaccharides (FOS) and/or galacto-oligosaccarides (GOS) are provided in an amount of 2-15 wt %.

18. Process according to claim 5, wherein the additional step of drying comprises spray-drying.

19. Process according to claim 8, wherein the aqueous medium is obtained by dispersing in water WPC or WPI with a protein content of at least 80 wt % based on dry matter.

20. Process according to claim 13, wherein the aqueous medium comprises 8-10 wt % non-digestible oligosaccharides selected from fructo-oligosaccharides (FOS) and/or galacto-oligosaccarides (GOS).
